(19) United States
(12) Patent Application Publication
(10) Pub. No.: US 2013/0218622 A1
(43) Pub. Date: Aug. 22, 2013

(54) AGGREGATING AVAILABILITY STATUS INFORMATION ON SHARED CALENDARS

(71) Applicants: Mark MacKenzie, Seattle, WA (US); Jason Cook, Renton, WA (US); Paul Tischhauser, Redmond, WA (US)

(72) Inventors: Mark MacKenzie, Seattle, WA (US); Jason Cook, Renton, WA (US); Paul Tischhauser, Redmond, WA (US)

(73) Assignee: Microsoft Corporation, Redmond, WA (US)

(21) Appl. No.: 13/399,979

(22) Filed: Feb. 17, 2012

(51) Int. Cl. G06Q 10/06

(52) U.S. Cl. 705/7.19

(57) ABSTRACT

A scheduling grid is provided for displaying summary availability information for a group of users in a collaborative environment. The system may enable users to share calendars with other users within the collaborative environment so that a meeting organizer can schedule a meeting at a time when all or most of the users are available. The system may collect availability information from the users' individual calendars and may aggregate the availability information in a master calendar, which may display the aggregated availability information for the group of users in a scheduling grid. Scheduling grid timeslots may display the aggregate availability information for the group of users and may graphically indicate when all users are available and when one or more users are unavailable during a timeslot. The aggregate availability information may enable the meeting organizer to quickly determine an available time for scheduling a meeting.

### BACKGROUND

In a collaborative environment, users may collaborate together on projects and may schedule meetings, appointments and conference calls in order to discuss projects and other collaboration items. Finding an available time when all users involved in a project are available to meet can be a challenge when there are many users with busy schedules. Collaborative environments typically enable users to share calendars over a cloud or similar networks so that the users can access and view other users' calendars and compare schedules in order to find a time that is available for all or most of the users to meet.

Typically, when viewing shared calendars of multiple users in order to schedule an event with the least number of conflicts, a meeting organizer may view the shared calendars of the multiple users, and the meeting organizer may have to scan through each of the shared calendars to find a time that is free for the meeting attendees. Some applications may combine the shared calendar information into a summary calendar, which may display the individual users' schedules side-by-side in rows within the summary calendar or similar fashion. The meeting organizer may scan the entire summary calendar in order compare each user's calendar and to identify an open timeslot that everyone has in common. This approach may work well when there are few users with relatively free calendars. However, it may become more difficult when the meeting includes many users with busy calendars and over large spans of time, and it may be difficult to keep track of and to identify open timeslots that are free for all of the users.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a system for providing a scheduling grid for displaying summary availability information for a group of users in a collaborative environment. The system may enable users to share calendars with other users within the collaborative environment so that a meeting organizer can schedule a meeting at a time when all or most of the users are available. The system may collect availability information from the users' individual calendars and may aggregate the availability information in a master calendar, which may display the aggregated availability information for the group of users in a scheduling grid. Scheduling grid timeslots may display the aggregate availability information for the group of users and may graphically indicate when the users are available and when one or more users are unavailable during a timeslot. The aggregate availability information may enable the meeting organizer to quickly determine an available time for scheduling a meeting.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a system for providing a master calendar for displaying the availability of multiple users in a collaborative environment, according to embodiments;

FIG. 2 illustrates an example scheduling grid displaying the availability of multiple users;

FIG. 3 illustrates an example scheduling grid displaying the availability of a group of users, according to embodiments;

FIG. 4 illustrates an example interface for displaying availability information for a group of users, according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process for displaying availability information for a group of users in a scheduling grid, according to embodiments.

### DETAILED DESCRIPTION

As briefly described above, a system is provided for managing a scheduling grid displaying summary availability information for a group of users in a collaborative environment. The system may enable users to share calendars such that each user may access and view the calendars of the other users within the collaborative environment. The ability to access and view the calendars of other users with the collaborative environment may enable a user to schedule a meeting with other users at a time and date that all or most of the users are available. The system may be configured to collect availability information from the users' personal calendars and to aggregate the availability information of the users in a master calendar which may provide condensed availability information for the group of meeting attendees in a scheduling grid where each cell represents a timeslot. Each timeslot may display the aggregate availability information for the group of users, and may graphically indicate when all users are available during a timeslot and when one or more users are unavailable during a timeslot. The aggregate availability information provided in the master calendar may enable the meeting organizer to scan an entire week to find an available time for scheduling a meeting when all or most of the meeting attendees are available.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing a scheduling grid displaying summary availability information for a group of users in a collaborative environment. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

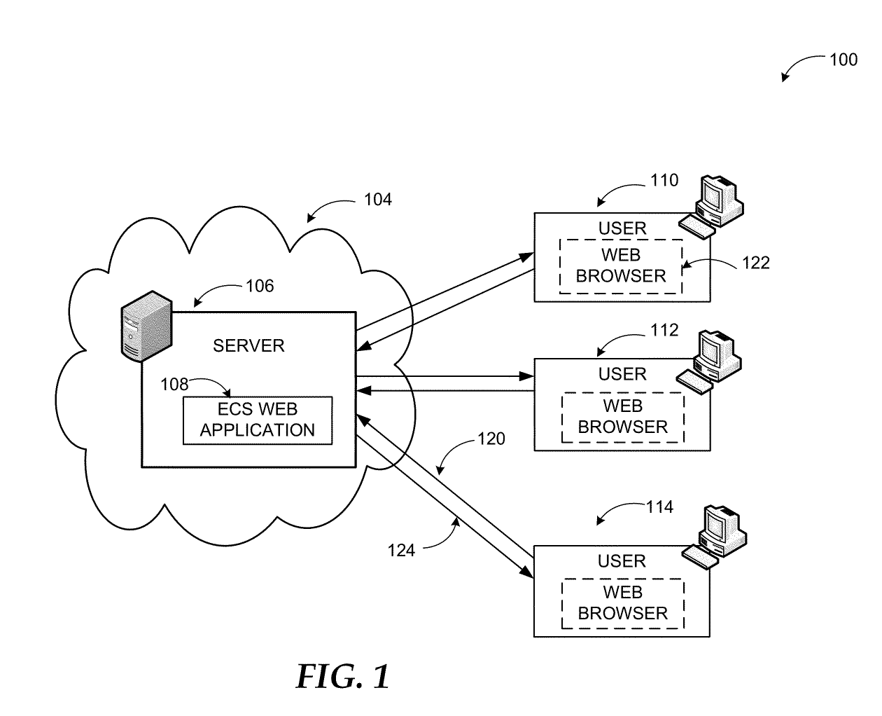

FIG. 1 illustrates a system for providing a master calendar for displaying the availability of multiple users in a collaborative environment, according to embodiments. A system according to embodiments may enable a user 110 to set up a meeting with other users (the meeting attendees 112, 114) within the collaborative environment based on the schedules and availability of each of the meeting attendees 112, 114. The system may aggregate availability information from each of the meeting attendees' personal calendars and may provide a master calendar of the meeting attendees' availability information which may enable the user scheduling the meeting (the meeting organizer) to determine a time and date for a meeting that all or a majority of the meeting attendees 112, 114 are available.

As demonstrated in diagram 100, a collaborative environment may enable one or more users to share documents and other resources, such as email, contacts and calendar information, over a cloud based or similar network 104. The users in the network 104 may use any web browser 122 on a client device, such as a laptop, PC, home computer, smart phone, etc., to access information, such as documents, files, email and other applications, stored on a server 106 within the network 104. In an example embodiment, the server 106 within the network 104 may host an application, such as a web service application, which may be an email, contact management, and scheduling (ECS) application that enables users to access their email, calendars and contacts from any client device on any web browser. The ECS application 108 may be, for example, Outlook Webapp® from MICROSOFT CORPORATION of Redmond, Wash.

A particularly useful feature of the network 104 may be the ability to share calendars with multiple users within the collaborative environment. The ECS application 108 may enable users to share calendars over the network 104 such that each user may access and view the calendars of the other users within the collaborative environment. The ability to access and view the calendars of other users within the collaborative environment may enable a user to schedule an event, such as a meeting or conference call, with several other users and to determine a time and date for the meeting that all or most of the users are available. In a typical calendar sharing scenario, users may schedule meetings by sharing calendars using the ECS application 108 and viewing them side by side so that the meeting organizer can compare the individual calendars to see each user's availability and find an available free time for a meeting.

In a system according to embodiments, the server 106 may be configured to collect availability information from the multiple users' personal calendars over the network 104, and the server 106 may aggregate the availability information of the users in a master calendar. The master calendar may provide condensed availability information for each of the users invited to the meeting (the meeting attendees 112, 114) and may present the condensed availability information for the group of meeting attendees in a scheduling grid. The scheduling grid may display, for example, a five or seven day week divided into hourly or half-hourly timeslots, and each timeslot may graphically display the aggregate availability information for each of the group of meeting attendees. In an example embodiment, if all of the meeting attendees 112, 114 are available at a particular time, the corresponding timeslot may indicate that there are no conflicts during that timeslot by appearing blank, and if one or more meeting attendees 112, 114 are unavailable at a particular time, the given timeslot may graphically indicate that there are one or more conflicts during the timeslot. In a further embodiment, the timeslots may graphically indicate the number or percentage of users that have a conflict during the timeslot.

The server 106 may provide the master calendar with the condensed availability information through the ECS application 108 to a web browser 122 on each user's individual client device where the users can access and view the master calendar. The aggregate availability information provided in the master calendar may enable the meeting organizer to easily scan an entire week to find a free time for scheduling a meeting when all or a majority of the meeting attendees 112, 114 are available, without having to scan each meeting attendee's 112 calendar separately and try to keep track of each user's individual schedule.

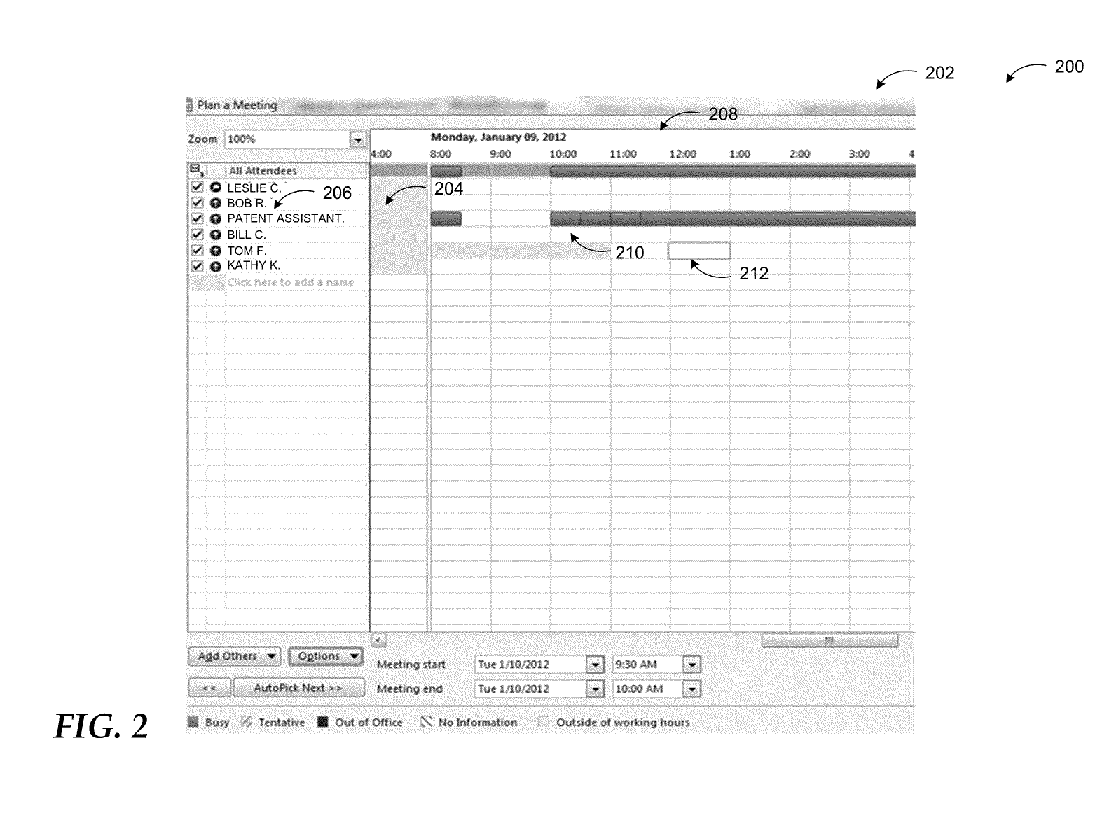

FIG. 2 illustrates an example scheduling grid displaying the availability of multiple users. As discussed previously in conjunction with FIG. 1, when viewing shared calendars of multiple users in order to schedule an event with the least number of conflicts, a meeting organizer may typically view one or more shared calendars of the multiple meeting attendees using an ECS application over a network, and the meeting organizer may have to scan through each of the shared calendars to find a time that is free for the meeting attendees. For example, each user may provide availability information on his or her personal calendar, such as times when the user is available, unavailable, working out of the office, and/or on vacation as some examples. When trying to schedule an event, the meeting organizer may view each user's availability information provided on each of the individual shared calendars, and the scheduling user may scan through each shared calendar to find an open time during which each meeting attendee is free and available.

Some applications may combine the shared calendar information into a single scheduling grid 202 as demonstrated in diagram 200. An example scheduling grid 202 may display separate rows 204 for each individual user and display separate columns 208 for the dates and times. The timeslot at the time column corresponding with each user's row may display each user's availability. For example, the timeslot corresponding to row for the patent assistant 206 and the Monday at 10:00 am column 210 may be blacked out 210 if the patent assistant 206 has marked that time as unavailable on his/her own personal calendar. In order for the meeting organizer to find an open timeslot 212 for scheduling a meeting or event, the meeting organizer may have to scan the entire scheduling grid and identify an open timeslot 212 for each and every user, and then try to identify an open timeslot 212 that everyone has in common.

This approach may work well when there is a small number of users with relatively free calendars, but may become more difficult when the meeting includes many users with busy calendars and over large spans of time. The scheduling grid 202 may become very dense with lots of information for the meeting organizer to parse, and it may be difficult to identify an open timeslot 212 that is free for all of the users. Additionally, the scheduling grid 202 may only display a small segment of times and dates and a limited number of users at a time. For example, the scheduling grid 202 may only be able to display six out of ten attendees for only a small segment of one day, and therefore the meeting organizer may have to scroll through the scheduling grid 202 to see more users and to view more timeslots. Continuous scrolling in order to see all of the users and all times and days may be tedious and time consuming, and it may be difficult to keep track of open timeslots when there are a large number of meeting attendees. A system that condenses the availability information may be easier to navigate and more efficient, because the information may be presented in a scheduling grid, which may display an entire week of availability information for all of the meeting attendees, with all the timeslots are viewable on the screen.

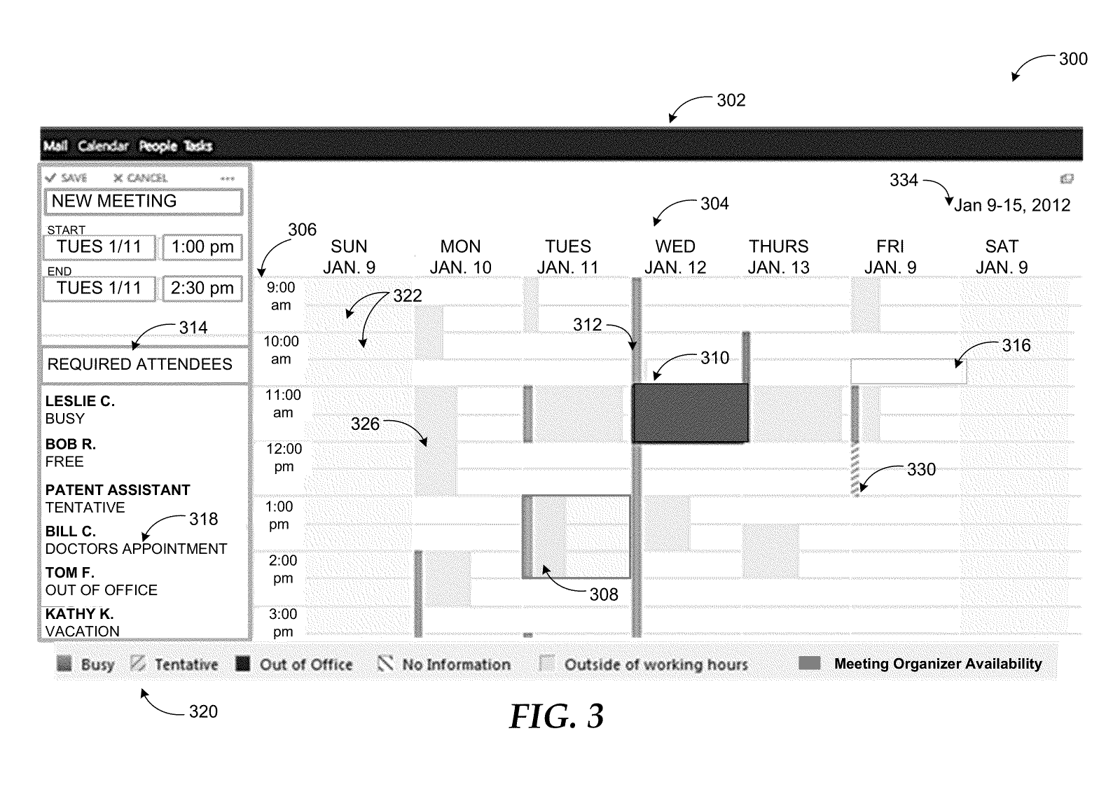

FIG. 3 illustrates an example scheduling grid displaying the availability of a group of users, according to embodiments. As demonstrated in diagram 300, a master calendar may condense the availability information from multiple users in a network into a scheduling grid 302. The scheduling grid 302 may display the availability information for the users (or meeting attendees 314) in a condensed week view, divided into hourly or other segmented cells or timeslots 322.

In an example embodiment, the scheduling grid 302 may display a full week 334 of condensed availability information from Sunday to Saturday, with the a period of time such as the days of the week as the columns 304 and sub-periods of the week, such as the hours of the day, e.g. 12:00 am to 12:00 am, as the rows 306. The hours may be divided into half-hour or smaller segments such that there may be 48 half-hour increment rows and 7 columns for a total of 336 cells or unit timeslots 322 on the scheduling grid. The timeslots 322 may be customized such that larger or smaller time segments and different dates may be displayed. For

As previously discussed, the server may collect the availability information for each of the 336 timeslots 322 from each user over the cloud based network using an ECS application. Each timeslot 322 may show the summary availability information for a group of meeting attendees rather than displaying individual availability info for each meeting attendee in a separate row. The server may evaluate the collected availability information from each of the users and aggregate the availability information to produce complete availability information for each timeslot 322 in the scheduling grid 302. The server may provide the scheduling grid 302 to the users on their own client devices through the ECS application over the network.

In a system according to embodiments, each timeslot on the scheduling grid may graphically display the aggregate availability information of the multiple users in the cloud based network. For example, if all of the users are free during an hour timeslot, the timeslot may be displayed as white or blank 316 to indicate that the timeslot is completely available. Further, the timeslot may be shaded 310 or blacked out if one or more of the meeting attendees are unavailable during that timeslot.

In a further embodiment, the scheduling grid may be configured to provide information as to the number or percentage of users that are unavailable during a timeslot. In an example scenario, a timeslot may use a percentage fill 326 or a bar graph method to indicate the percent of users having a conflict during that timeslot. For example, if on Tuesday from 1:00 pm to 2:30 pm, two of five meeting attendees are unavailable, then the timeslot may display a bar 308 covering 40% of the timeslot. In another embodiment, the timeslot may be color coded and/or shaded, such that each color or shade indicates a percent availability, and may display a range of availability statuses for the group of users in a timeslot on the scheduling grid. As an example, each color or distinct shade may represent a range of percentages, e.g. 0%, 1-25%, 26-50%, 51%-75%, 76-99%, and 100%, so that a user can quickly scan the scheduling grid 302 and identify free or relatively free timeslots based on the percent fill, color or shades/shading of the timeslot.

In a further embodiment, the server may take into account each individual user's availability status when aggregating the availability information for the scheduling grid 302. For example, a user may set an availability status such as unavailable, busy, away, tentative, working out of office, free, on vacation, etc. The availability statuses may be pre-established as unavailable or free, and the server may evaluate these availability statuses when displaying aggregate availability information in a timeslot on the scheduling grid 302. For example, a working out of office or tentative status may be determined to be available, and vacation or busy may be determined to be unavailable. Additionally, the server may determine that when a user has other events scheduled 318 during a timeslot such as a meeting, appointment, or conference call, the user may be determined to be unavailable for that timeslot. Further, the scheduling grid 302 may include a graphical scheme 320 such as a shading scheme 330 to indicate a spectrum of user's availability. For example, a certain type of shading scheme 330, may indicate that some users are tentatively available, and the unit timeslot may display a portion of the cell as free and another portion of the cell with the tentative shading scheme. Additionally, varying shades may represent a percentage of users who are unavailable.

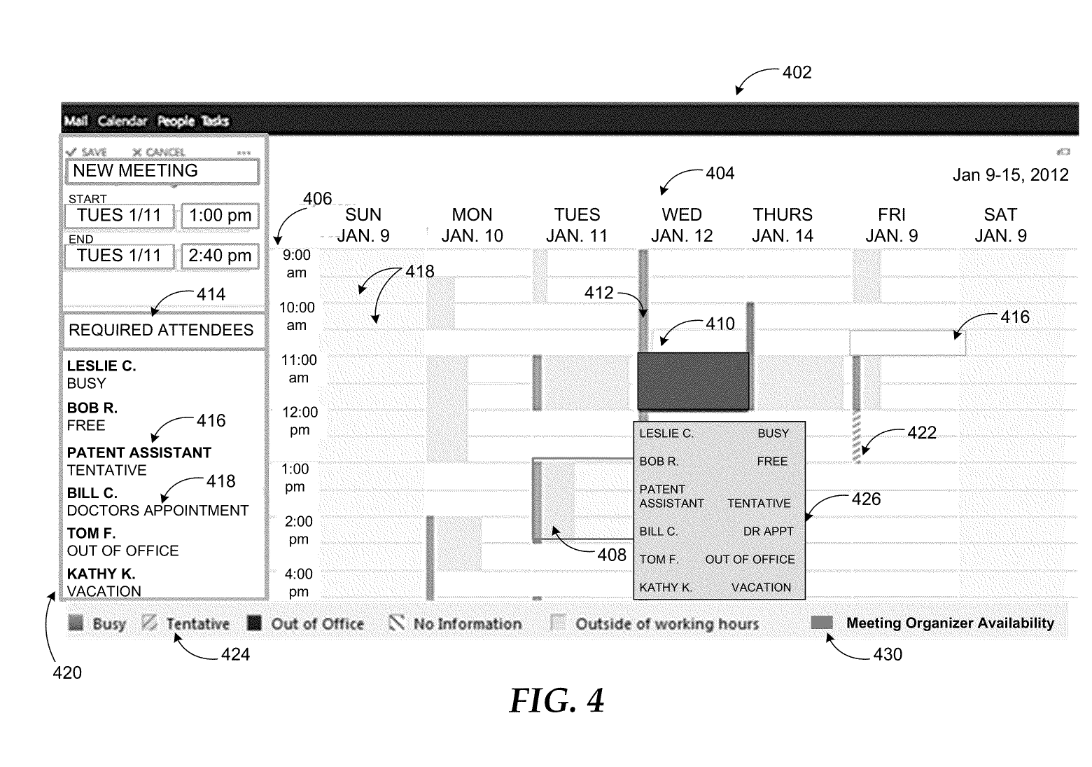

FIG. 4 illustrates an example interface for displaying availability information for a group of users, according to embodiments. As previously described above, a variety of schemes may be used to indicate the availability of a group of users during a particular timeslot 418. A binary status scheme, such as black and white or shaded 410 and not shaded 416, may indicate that a particular timeslot 418 is either free for all users or unavailable for at least one user. A multi-status scheme such as a color coding or shading scheme may be used to graphically indicate a range of statuses or multiple statues. A color coding or shading scheme 424 corresponding to a scale or percent of available users may be used to indicate the number or percent of users that are available during a particular timeslot 418. Moreover, a graph scheme such as a bar 408 may fill a timeslot 418 to display the percent of users available during the timeslot 418. Other shading, graphical and textual schemes may also be used for indicating to a meeting organizer the availability status of a group of meeting attendees during each timeslot 418. In an example embodiment, the scheduling grid 402 display may be automatically pre-set, and it may additionally be user customized such that a user may configure the availability indication scheme that the user prefers for displaying availability information in the scheduling grid timeslot 418.

In a further embodiment, the scheduling grid 402 may be configured to additionally display more detailed availability information for each meeting attendee at a selected time. The meeting organizer may select and click on a timeslot 418, and upon selection the detailed availability information may be provided. The detailed availability information may be displayed as a pop-up window 426 user interface in front of the scheduling grid, and in another embodiment, it may be displayed as a separate window 420 as a separate user interface next to the scheduling grid. The detailed availability information may include a list of the meeting attendees 414 and each of their availability statuses and calendar information such as whether the user is available, free, tentative, or whether the user has another event scheduled during that timeslot 418. This feature may enable the meeting organizer to see condensed summary availability information for the group of meeting attendees across an entire wee, month, or other selected period of time, and also the ability to see the more detailed information for each meeting attendee in order to make a decision about scheduling an event during a particular timeslot 418.

In yet another embodiment, the scheduling grid may be configured to display the meeting organizer user's personal availability information 412 along with the scheduling grid so that the meeting organizer can compare his/her own availability with that of the group. The meeting organizer's calendar information may be displayed in an independent graphical scheme 430, such that it is clear which availability information corresponds to the meeting organizer. For example, the meeting organizer's availability information 412 may be displayed in a contrasting color or pattern on the scheduling grid.

The example systems in FIG. 1 through 4 have been described with specific configurations, applications, and interactions. Embodiments are not limited to systems according to these examples. A system for providing a scheduling grid displaying summary availability information for a group of users in a collaborative environment may be implemented in configurations employing fewer or additional components and performing other tasks. Furthermore, specific protocols and/or interfaces may be implemented in a similar manner using the principles described herein.

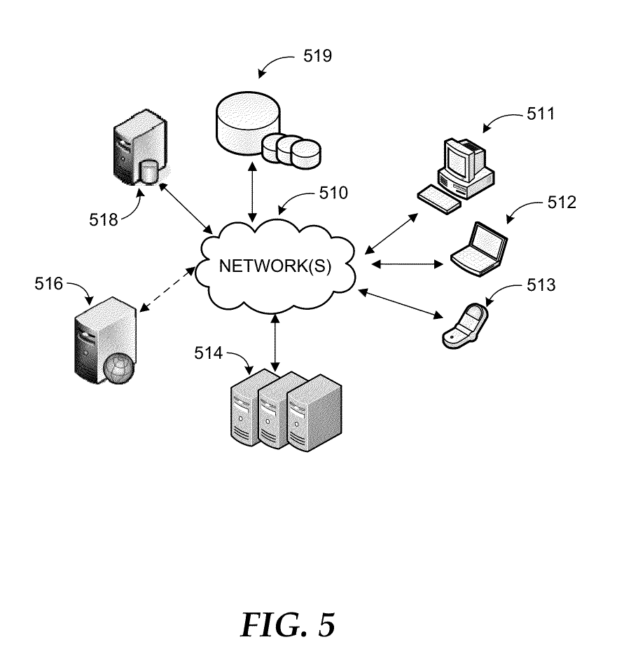

FIG. 5 is an example networked environment, where embodiments may be implemented. A system for providing a scheduling grid displaying summary availability information for a group of users in a collaborative environment may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. An application executed on one of the servers may facilitate providing a master calendar including a scheduling grid for displaying summary availability information for a group of users in a collaborative environment The application may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform for providing a scheduling grid for displaying summary availability information for a group of users in a collaborative environment. Furthermore, the networked environments discussed in FIG. 5 are for illustration purposes only. Embodiments are not limited to the example applications, modules, or processes.

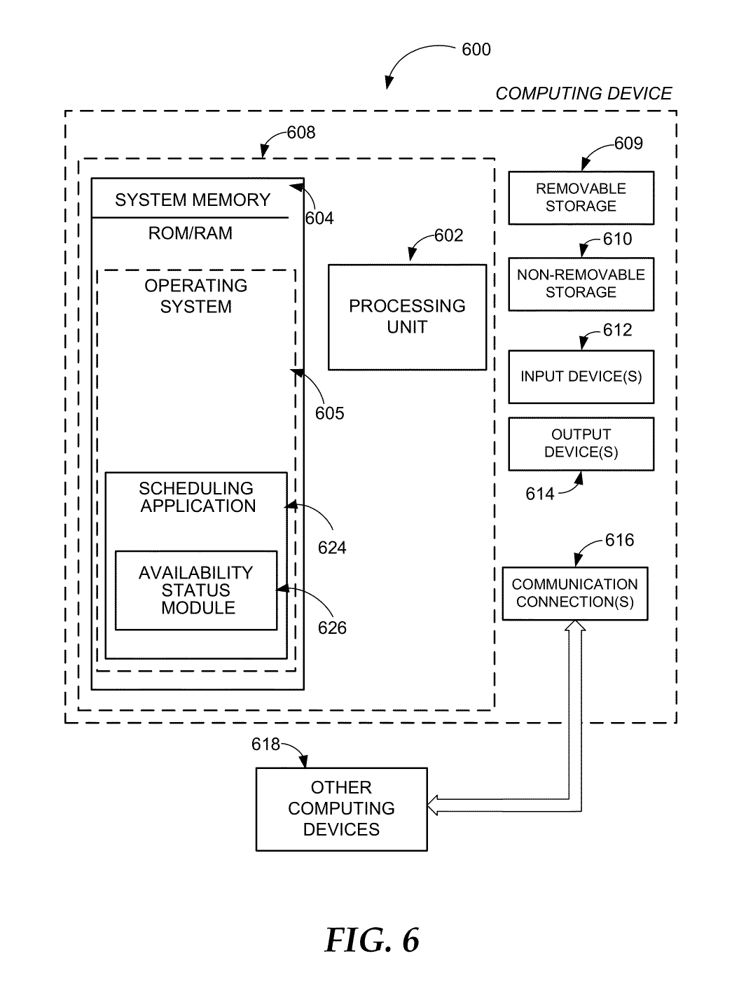

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing an application for providing a scheduling grid displaying summary availability information for a group of users in a collaborative environment according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as a scheduling application 624 and availability status module 626.

The scheduling application 624 may facilitate enabling users to share personal calendars over a network and aggregating personal availability information from the personal calendars into a master calendar including a scheduling grid with summary availability information for the group of users. Scheduling application 624 may enable a computing device 600 to continually retrieve availability information from each of the users within the cloud based network. Through the availability status module 626, scheduling application 624 may condense the availability information for each user within the network in order to provide summary availability information for the group of users and to present the summary availability information in the scheduling grid. Scheduling application 624 and availability status module 626 may be separate applications or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

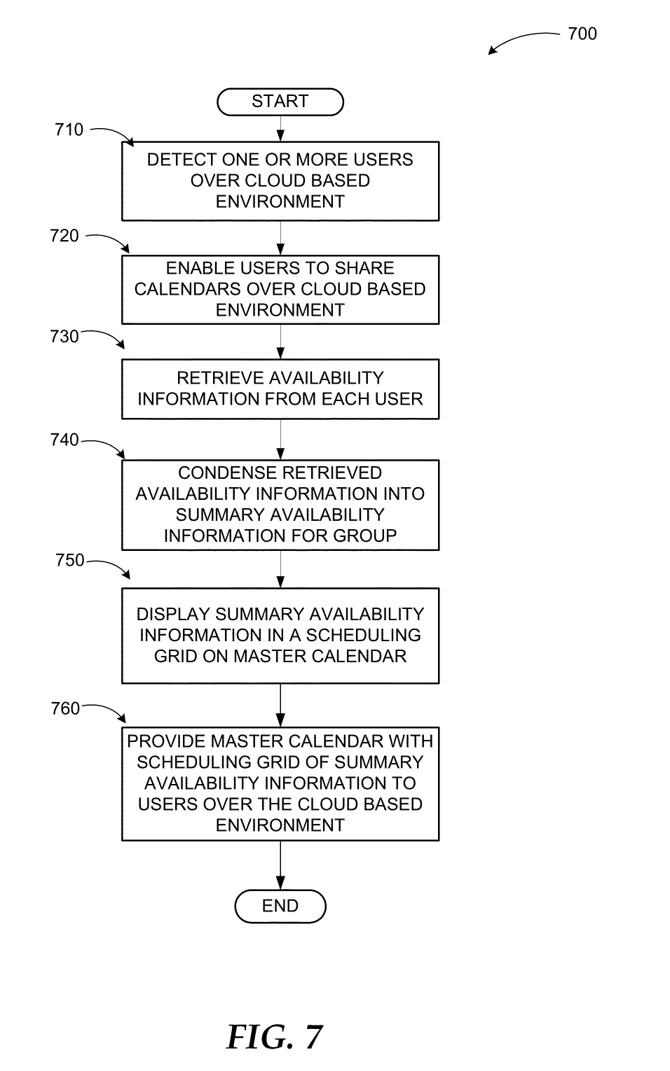

FIG. 7 illustrates a logic flow diagram for process 700 for providing a scheduling grid displaying summary availability information for a group of users in a collaborative environment according to embodiments. Process 700 may be implemented on a computing device or similar electronic device capable of executing instructions through a processor.

Process 700 begins with operation 710, where the system may detect one or more users over a collaborative environment. The collaborative environment may be any type of networked environment (e.g., a cloud based environment) enabling users to use any client application such as a web browser on a client device to access information, such as documents, files, email and other applications, stored on a server within the collaborative environment. At operation 720, the system may enable one or more users within the collaborative environment to share personal calendars over the collaborative environment. The collaborative environment may enable document and resource sharing using between users, including the ability to share, access, and view calendars of the multiple users within the collaborative environment. In an example embodiment, a server within the collaborative environment may host an application, such as a web service application, which may be an email, scheduling and contact management application that enables users to access their email, calendars and contacts from any client device on any browser.

At operation 730, the system may retrieve availability information from each user within the collaborative environment. The availability information may include availability statuses set by the user on the user's personal calendar, such as away, busy, free, and out of the office, and may also include appointments and other events that the user has scheduled on his personal calendar. At operation 740, the system may condense the retrieved availability information from each user into summary availability information for the group of users. The system may evaluate the collected availability information from each of the users and aggregate the availability status information to produce complete summary availability information for the group of users within the collaborative network rather than providing individual availability information for each individual user.

At operation 750, the system may display the condensed summary availability information for the group of users in a scheduling grid on a master calendar. The scheduling grid on the master calendar may provide summary availability information for the group of users across an entire week. Each day of the week may include timeslots for the hours of the day, and each timeslot may show the summary availability information for group of users during that timeslot. The scheduling grid may also be configured to display more detailed availability information for each user in a separate additional window.

At operation 760 the system may provide the master calendar with the scheduling grid of the summary availability information to the users over the collaborative environment. The system may provide the master calendar with the scheduling grid displaying the condensed availability information through the application to a browser on each user's individual client device where the users can access and view the master calendar.

The operations included in process 700 are for illustration purposes. Providing a scheduling grid for displaying summary availability information for a group of users in a collaborative environment may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing a scheduling grid displaying summary availability information for a group of users in a collaborative environment, the method comprising:
detecting one or more users in the collaborative environment;
enabling the one or more users to share each user's personal calendar over the collaborative environment;
retrieving availability information from each of the one or more users' personal calendars;
condensing the retrieved availability information from each of the one or more users into summary availability information;
displaying the summary availability information for the group of users in a scheduling grid on a master calendar; and
providing the master calendar with the scheduling grid to each of the one or more users over the collaborative environment.

2. The method of claim 1, further comprising:
evaluating the retrieved availability information from each of the one or more users, wherein the retrieved availability information includes one of a plurality of statuses; and
determining whether each of the one or more users is available or unavailable based on reducing the plurality of statuses to a binary status set.

3. The method of claim 1, further comprising:
displaying a period of summary availability information on the scheduling grid, wherein the period is one of a day, a week, and a month, and wherein columns of the scheduling grid represent sub-periods of the period and rows of the scheduling grid represent sub-periods of the sub-periods such that each cell on the scheduling grid is a unit timeslot.

4. The method of claim 1, further comprising:
graphically displaying the summary availability information for the group of users for each timeslot on the scheduling grid.

5. The method of claim 4, further comprising:
displaying a timeslot as blank if each user in the group of users is available during the timeslot; and
displaying a timeslot as shaded if one or more users in the group of users is unavailable during the timeslot.

6. The method of claim 4, further comprising:
graphically indicating a percentage of users in the group of users who are unavailable during a timeslot.

7. The method of claim 6, further comprising:
employing a percentage fill scheme to indicate a percentage of users who are unavailable during a timeslot, wherein a portion of the timeslot corresponding to the percent of users who are unavailable is shaded.

8. The method of claim 6, further comprising:
employing a shading scheme to indicate the percentage of users who are unavailable during a timeslot, wherein varying shades represent a percentage of users who are unavailable.

9. The method of claim 1, further comprising:
enabling a user to select a timeslot on the scheduling grid in order to view detailed availability information for the group of users during the selected timeslot.

10. The method of claim 9, further comprising:
when the user selects the timeslot on the scheduling grid to view detailed availability information, displaying the detailed availability information in a pop-up user interface.

11. The method of claim 9, further comprising:
when the user selects the timeslot on the scheduling grid to view detailed availability information, displaying the detailed availability information on a separate user interface next to the scheduling grid.

12. A server for providing a scheduling grid displaying summary availability information for a group of users in a collaborative environment, the server comprising:
a memory storing instructions;
a processor coupled to the memory, the processor executing a scheduling application, wherein the scheduling application is configured to:
detect one or more users in the collaborative environment;
enable the one or more users to share each user's personal calendar over the collaborative environment;
retrieve availability information from each of the one or more users' personal calendars;
evaluate the retrieved availability information from each of the one or more users;
condense the retrieved availability information from each of the one or more users into summary availability information;
display the summary availability information for the group of users in a scheduling grid on a master calendar; and
provide the master calendar with the scheduling grid to each of the one or more users over the collaborative environment.

13. The server of claim 12, wherein the scheduling application is further configured to:
determine whether each of the one or more users is available or unavailable based on an availability status set by each of the one or more users, wherein the availability status includes one of: free, available, unavailable, busy, away, out of office, on vacation, working elsewhere, and tentative; and
identify a user as unavailable during a timeslot if the user has a status other than free and working elsewhere.

14. The server of claim 12, wherein the scheduling application is further configured to:
display summary availability information on the scheduling grid for a week, wherein columns of the scheduling grid represent days of the week and rows of the scheduling grid represent hours during each day, such that each cell on the scheduling grid is a timeslot that represents a day and a time during the week; and
display the summary availability information for the group of users during each timeslot on the scheduling grid.

15. The server of claim 14, wherein the scheduling application is further configured to:
employ a shading scheme to graphically display a range of availability statuses for the group of users in a timeslot on the scheduling grid, wherein each availability status is represented by a distinct shade, and portions of the timeslot are shaded corresponding to a percent of users having a predefined availability status.

16. The server of claim 12, wherein the scheduling application is further configured to:
display a user's personal availability information along with the summary availability information for the group of users on the scheduling grid.

17. The server of claim 16, wherein the user's personal availability information is displayed in a shade different than the shade of the summary availability information for the group of users in each timeslot on the scheduling grid.

18. A computer-readable memory device with instructions stored thereon for providing a scheduling grid displaying summary availability information for a group of users in a collaborative environment, the instructions comprising:
detecting one or more users in the collaborative environment;
enabling the one or more users to share each user's personal calendar over the collaborative environment;
retrieving availability information from each of the one or more users' personal calendars;
evaluating the retrieved availability information from each of the one or more users;
determining whether each of the one or more users is available or unavailable based on an availability status set by each of the one or more users, wherein the set availability status includes one of: free, available, unavailable, busy, away, out of office, on vacation, working elsewhere, and tentative;
condensing the retrieved availability information from each of the one or more users into summary availability information employing one of a binary and a multi-status scheme;
displaying the summary availability information for the group of users in a scheduling grid on a master calendar; and
providing the master calendar with the scheduling grid to each of the one or more users over the collaborative environment.

19. The computer-readable memory device of claim 18, wherein the instructions further comprise:
displaying a week of summary availability information on the scheduling grid, wherein columns of the scheduling grid represent days of the week and rows of the scheduling grid represent hours during each day, such that each cell on the scheduling grid is a timeslot that represents a day and a time during the week; and
employing one or more of a color coding scheme, a graph scheme, a shading scheme, and a textual scheme to graphically display the summary availability information for the group of users during each timeslot on the scheduling grid.

20. The computer-readable memory device of claim 18, wherein the instructions further comprise:
automatically establishing a scheme for displaying the summary availability information for the group of users on the scheduling grid; and
enabling the scheme for displaying the summary availability information to be customized by a user.
